(19) United States
(12) Patent Application Publication
(10) Pub. No.: US 2023/0119026 A1
(43) Pub. Date: Apr. 20, 2023

(54) COOKING CONTAINER

(71) Applicant: Gukang Co., Ltd., New Taipei City (TW)

(72) Inventor: Jin-Hong CHIEN, New Taipei City (TW)

(21) Appl. No.: 17/503,854

(22) Filed: Oct. 18, 2021

(51) Int. Cl. A47J 45/06

(52) U.S. Cl. CPC A47J 45/068; A47J 2202/00

(57) ABSTRACT

A cooking container includes a container unit and a temperature information processor disposed on the container unit. A bottom of the container unit is a heated region to carry a heat source, and a side wall of the container unit is provided at least with a temperature-sensing element channel which is extended to a location close to a center of the heated region. A temperature-sensing element which is connected with the temperature information processor is extended deeply into a location close to the center of heated region from the temperature-sensing element channel, allowing the temperature detected to be close to the actual heated temperature of the cooking container.

### BACKGROUND OF THE INVENTION

### A) Field of the Invention

The present invention relates to a cooking container, and more particular to a cooking container wherein a temperature that is close to an actual heated temperature can be detected.

### B) Description of the Prior Art

For some cooking containers that a heated condition can be displayed, a container unit is usually installed with a display device or element to present the temperature condition. The display device is connected with a temperature-sensing element which is extended to the container unit, receiving the temperature information from the temperature-sensing element and presenting the heated condition of container unit using a setup mode in the display device.

The temperature-sensing element of the conventional cooking container is usually only extended to a side wall of or the side wall close to a bottom of the container unit. Therefore, the detected temperature is not the actual heated temperature of the cooking container. This phenomenon is particularly obvious in a low-power cooking condition; the actual heated condition of the cooking container cannot be aware of actually, and it is not easy to detect when idle-burning occurs or stove fire is extinguished.

### SUMMARY OF THE INVENTION

The primary object of the present invention is to provide a cooking container wherein the temperature that is close to the actual heated temperature can be detected.

The present invention discloses a cooking container, comprising a container unit, a bottom of which is a heated region to carry a heat source, with a periphery of the heated region being surrounded with a side wall extending upward; and a temperature information processor which is disposed at the container unit and is connected at least with a temperature-sensing element. In addition, the cooking container is provided at least with a temperature-sensing element channel which is extended from the side wall to a location close to the center of heated region, on the container unit corresponding to the temperature information processor. The temperature-sensing element is extended deeply into a location close to the center of heated region from the temperature-sensing element channel, such that the temperature detected by the temperature-sensing element can be close to the actual heated temperature of the cooking container.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural drawing of external appearance, according to a first embodiment of the present invention.

FIG. 2 shows a local cutaway view of the first embodiment of the present invention.

FIG. 3 shows a schematic view of usage state, according to the present invention.

FIG. 4 shows a local cutaway view of a second embodiment of the present invention.

FIG. 5 shows a local cutaway view of a third embodiment of the present invention.

FIG. 6 shows a local cutaway view of a fourth embodiment of the present invention.

FIG. 7 shows a local cutaway view of a fifth embodiment of the present invention.

### DETAILED DESCRIPTION OF THE PREFERRED EMBODIMENTS

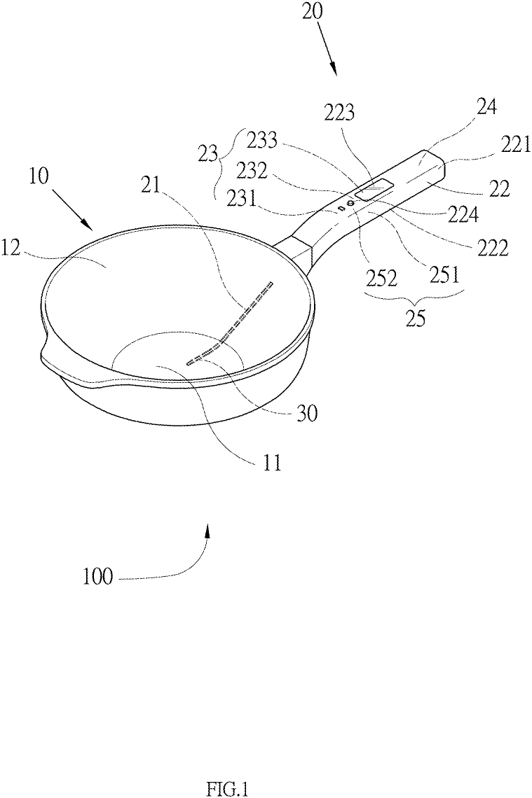

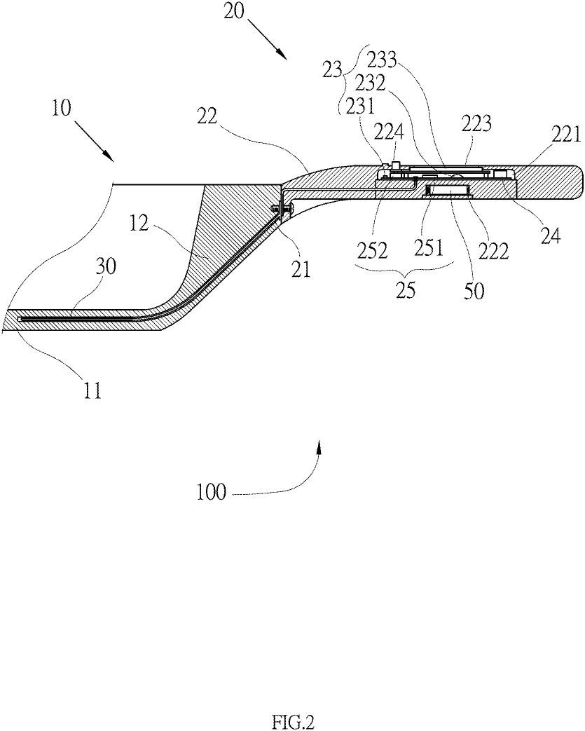

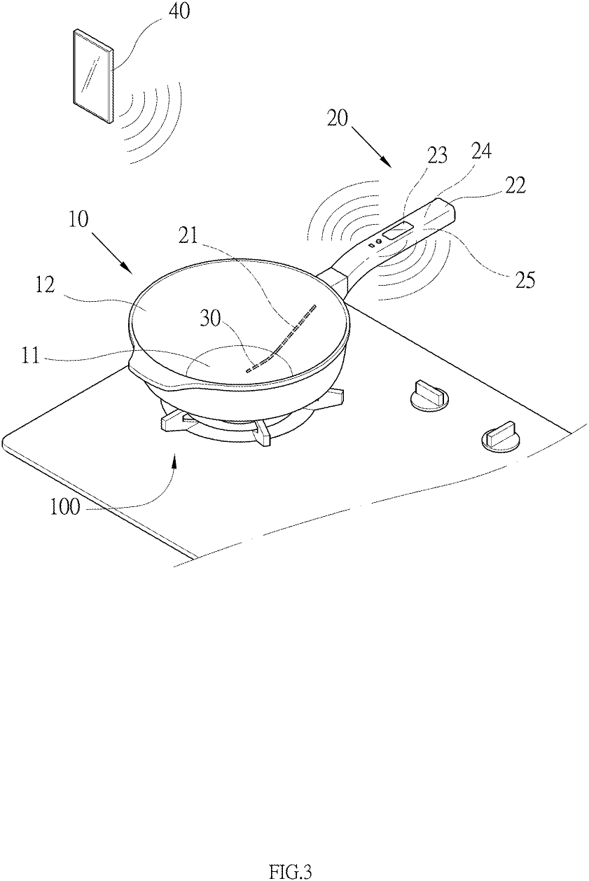

Referring to FIGS. 1 to 3, the present invention provides a cooking container, comprising a container unit 10 to accommodate foods to be cooked, with a bottom of the container unit 10 being a heated region 11 to carry a heat source, and a periphery of the heated region 11 being surrounded with a side wall 12 extending upward; and a temperature information processor 20, which is disposed at the container unit 10 and is connected at least with a temperature-sensing element 21 extending to the container unit 10. In the drawings, the cooking container 100 is manifested as a wok. The side wall 12 of the container unit 10 is provided with a handle, and an assembly part 22 of the temperature information processor 20 is manifested as the handle.

The temperature information processor 20 includes basically the assembly part 22 which is combined with the container unit 10, a display module 23 which is disposed at the assembly part 22 and is connected at least with a temperature-sensing element 21, presenting the temperature information detected by the temperature-sensing element 21 from a setup mode of the display module 23.

The cooking container 100 is provided at least with a temperature-sensing element channel 30 which is extended to a location close to a center of the heated region 11 from the side wall 12, on the container unit 10 corresponding to the temperature information processor 20. At least one temperature-sensing element 21 is extended deeply into a location close to the center of heated region 11 from at least one temperature-sensing element channel 30.

In implementation, the temperature information processor 20 can further include a wireless signal communication module 24 and a control module 25. The wireless signal communication module 24 is disposed at the assembly part 22 to transmit information with a corresponding external monitoring device 40. The control module 25 is disposed at the assembly part 22 and is connected electrically with at least one temperature-sensing element 21, the display module 23, and the wireless signal communication module 24. The control module 25 is used to integrate the information transmission among at least one temperature-sensing element 21, the display module 23, and the wireless signal communication module 24.

The assembly part 22 is provided with a holding space 221 and a battery holding part 222. Electricity required for the entire operation of temperature information processor 20 is provided by a battery 50 installed in the battery holding part 222. On the other hand, the display module 23, the wireless signal communication module 24, and the control module 25 are disposed in the holding space 221 to acquire a better shielding effect.

Furthermore, a holding space 221 in the display module 23 is provided at least with an optoelectronic element 231 which generates a corresponding light after being energized, a buzzer 232 which generates corresponding audio after being energized, and a liquid crystal display board 233. The assembly part 22 is provided with a window 223 corresponding to the liquid crystal display board 233, and an area of assembly part 22 corresponding to each optoelectronic element 231 can provide for light to reveal.

An interior of the holding space 221 in the control module 25 is provided with a microcontroller 251 and at least a push switch 252. The assembly part 22 can be further provided at least with a floating button 224 relative to the push switch 252.

For the cooking container 100 provided by the present invention, through the design that the container unit 10 is provided at least with a temperature-sensing element channel 30 which is extended to a location close to the center of heated region 11, at least one temperature-sensing element 21 can be extended deeply into the location close to the center of heated region 11, allowing the temperature detected by at least one temperature-sensing element 21 to be close to the actual heated temperature, so that a user can be aware of the duration and degree of heating easily, which facilitates reacting in time to an abrupt condition that a stove is idle-burning or stove fire is extinguished.

Especially, the temperature information can be transmitted to the corresponding external monitoring device 40 through the wireless signal communication module 24, or the signal sent from the corresponding external monitoring device 40 can be received through the wireless signal communication module 24. The wireless signal communication module 24 can be an RF (Radio Frequency) receiving/transmitting module that complies with the ZigBee protocol, the Bluetooth protocol or the Wi-Fi protocol, to transmit information with the corresponding external monitoring device 40.

The external monitoring device 40 that corresponds to the wireless signal communication module 24 can be a smart phone or other remote monitoring device as shown in the drawings, which facilitates the object used by the external monitoring device 40 to react in time, helps receiving the signal sent from the corresponding external monitoring device 40 through the wireless signal communication module 24, or facilitates the object used by the external monitoring device 40 to turn off or switch the prompting function of the display module 23, thereby further improving the practicality and the convenience in operation of the entire cooking container 100.

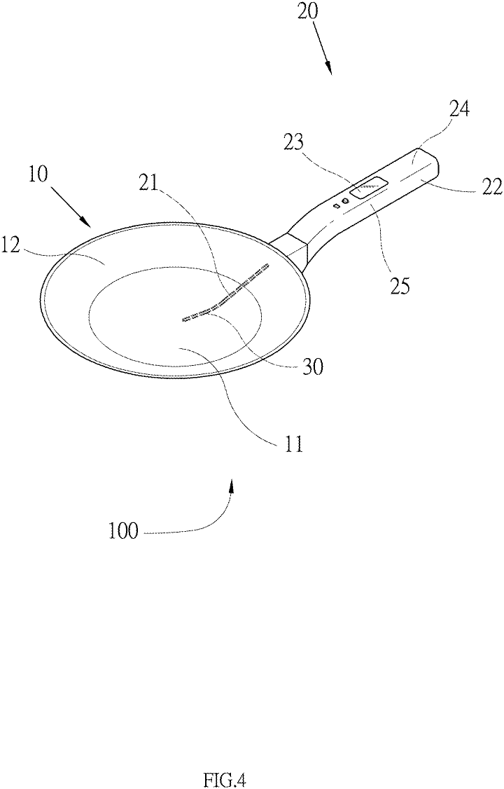

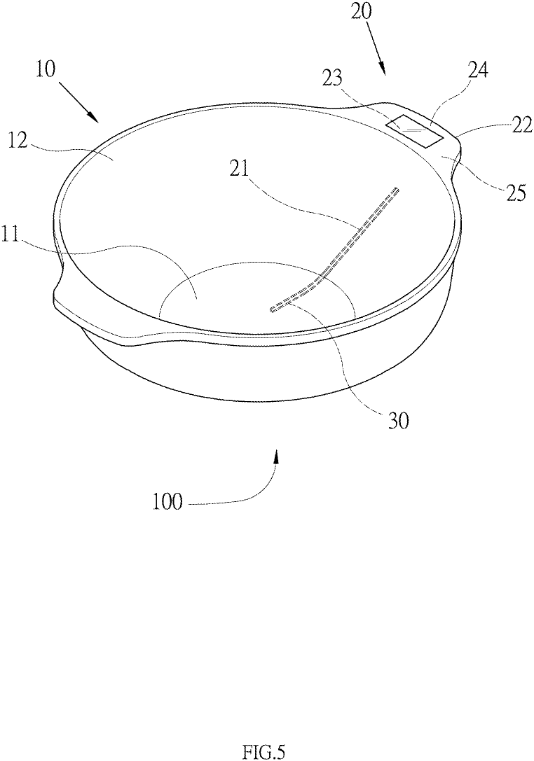

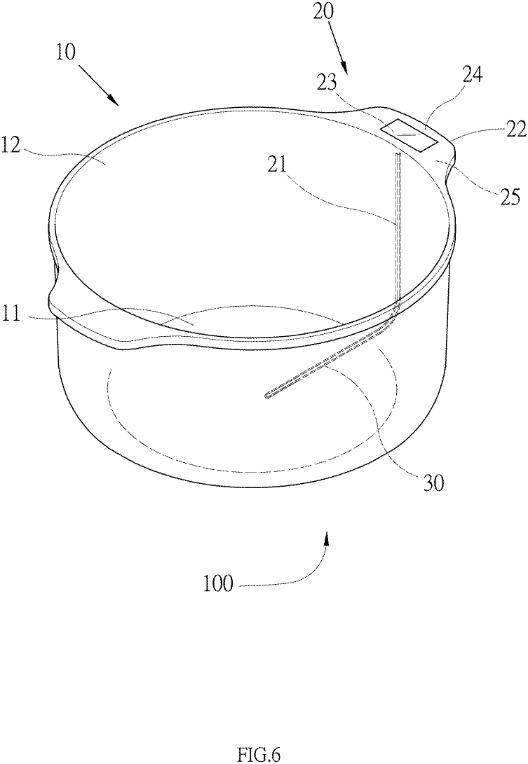

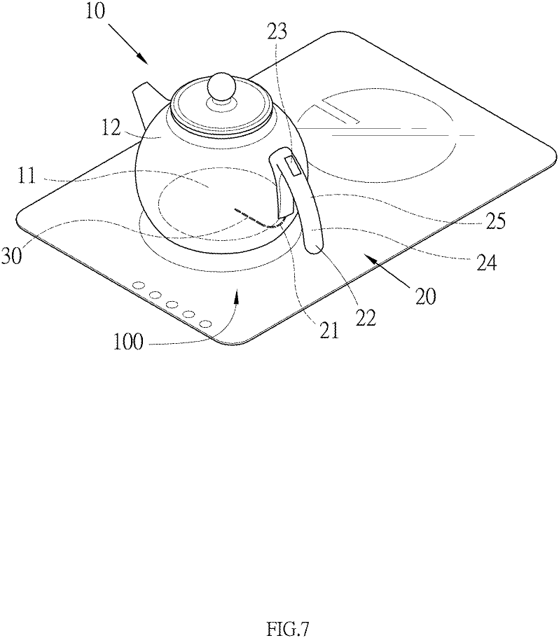

As there are many kinds of cooking containers on the market, the cooking container 100 of the present invention can be manifested as an implementation of wok (FIG. 1), frying pan (FIG. 4), Dutch oven (FIG. 5), stockpot (FIG. 6) or boiling kettle (FIG. 7).

Moreover, whether using a heat source provided by gas, fuel oil or electricity, the cooking container 100 of the present invention can all achieve the effect of allowing the temperature detected by the temperature-sensing element to be close to the actual heated temperature.

Specifically, the temperature detected by the cooking container according to the present invention can be close to the actual heated temperature of the cooking container, so that the user can be aware of the duration and degree of heating in cooking easily, and can react in time to the abrupt condition that a stove is idle-burning or stove fire is extinguished. In addition, the present invention facilitates the object used by the external monitoring device to turn off or switch the prompting function of the display module, thereby further improving the practicality and convenience in operation of the cooking container.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A cooking container, comprising:
a container unit, a bottom of which is a heated region to carry a heat source, with a periphery of the heated region being surrounded with a side wall extending upward; and
a temperature information processor, which is disposed at the container unit and is connected with a temperature-sensing element;
wherein, the cooking container is provided with a temperature-sensing element channel which is extended to a location close to a center of the heated region from the side wall, on the container unit corresponding to the temperature information processor, with that the temperature-sensing element is extended deeply into a location close to the center of heated region from the temperature-sensing element channel.

2. The cooking container according to claim 1, wherein the temperature information processor includes an assembly part, which is combined with the container unit; and a display module, which is disposed at the assembly part and is connected with the temperature-sensing element to present the temperature information detected by the temperature-sensing element using a setup mode.

3. The cooking container according to claim 1, wherein the temperature information processor includes an assembly part, which is combined with the container unit; a display module, which is disposed at the assembly part and is connected with the temperature-sensing element to present the temperature information detected by the temperature-sensing element using a setup mode; and a control module, which is disposed at the assembly part and is connected electrically with the temperature-sensing element and the display module, to integrate the information transmission between the temperature-sensing element and the display module, with that the assembly part is provided with a battery holding part to connect electrically the display module and the control module.

4. The cooking container according to claim 1, wherein the temperature information processor includes an assembly part, which is combined with the container unit; a display module, which is disposed at the assembly part and is connected with the temperature-sensing element to present the temperature information detected by the temperature-sensing element using a setup mode; a wireless signal communication module, which is disposed at the assembly part to transmit information with a corresponding external monitoring device; and a control module, which is disposed at the assembly part and is connected electrically with the temperature-sensing element, the display module, and the wireless signal communication module, to integrate the information transmission among the temperature-sensing element, the display module, and the wireless signal communication module, with that the assembly part is provided with a battery holding part to connect electrically the display module, the control module, and the wireless signal communication module.

5. The cooking container according to claim 4, wherein the assembly part is provided with a holding space, whereas the display module, the wireless signal communication module, and the control module are disposed in the holding space, with that the display module is provided in the holding space with an optoelectronic element which generates corresponding light after being energized, a buzzer which generates corresponding audio after being energized, and a liquid crystal display board, with that the assembly part is provided with a window corresponding to the liquid crystal display board, and with that the control module is provided in the holding space with a microcontroller and a push switch.

6. The cooking container according to claim 5, wherein an area of assembly part corresponding to the optoelectronic elements allow light to reveal.

7. The cooking container according to claim 5, wherein the assembly part is provided with a floating button relative to the push switch.
